(19) United States
(12) Patent Application Publication
(10) Pub. No.: US 2017/0336523 A1
(43) Pub. Date: Nov. 23, 2017

(54) SEISMIC SIGNAL PROCESSING METHOD, APPARATUS AND SYSTEM

(71) Applicant: INSTITUTE OF GEOLOGY AND GEOPHYSICS, CHINESE ACADEMY SCIENCES, Chaoyang District, Beijing (CN)

(72) Inventor: Jinhai Zhang, Beijing (CN)

(73) Assignee: INSTITUTE OF GEOLOGY AND GEOPHYSICS, CHINESE ACADEMY SCIENCES, Chaoyang District, Beijing (CN)

(21) Appl. No.: 15/533,247

(22) PCT Filed: Jul. 30, 2015
(86) PCT No.: PCT/CN2015/085576

§ 371 Date: Jun. 5, 2017

(51) Int. Cl. G01V 1/30

(52) U.S. Cl. CPC G01V 1/303; G01V 2210/6222; G01V 2210/626

(57) ABSTRACT

The present invention provides a seismic signal processing method, device and system. The method comprises: obtaining an offset of a reflected seismic signal at a sampling point and the corresponding reflected wave arrival time; constructing a non-hyperbolic dynamic correction formula based on Pade approximation according to the offset of the reflected seismic signal at the sampling point and the corresponding reflected wave arrival time; extracting a vertical propagation velocity and anisotropy parameters of the reflected seismic signal according to the non-hyperbolic dynamic correction formula constructed based on Pade approximation.

### TECHNICAL FIELD

The present invention relates to the field of seismic exploration, particularly relates to a seismic signal processing method, device and system.

### BACKGROUND

Seismic exploration is the most important means to seek petroleum and natural gas. A seismic signal similar to a pulse is excited by detonating explosives which are buried in the borehole on the earth's surface (that is, to stimulate an artificial hypocenter), and the reflected seismic signal from the underground objectives is received by a geophone buried on the earth's surface. Finally, the structural information of the underground objectives, and even the seismic attribute information can be obtained by processing the received seismic signal, so as to provide an important reference for subsequent drilling arrangement. Herein, the seismic signal comprises the seismic signal from the artificial hypocenter and the reflected seismic signal from the underground objectives, and the processed seismic signal refers to the reflected seismic signal from the underground objectives received by the geophone.

At present, it is an important part in the seismic signal processing to extract anisotropy parameters and a vertical propagation velocity of the geological layer from the seismic signal based on the assumption that the underground medium is the VTI anisotropic medium. The so-called VTI anisotropic medium refers to the transversely isotropic medium with a vertical symmetry axis, which is the most common case of various anisotropic models and has a good correlation with the deposition of underground medium and shale formation, etc.; while the anisotropic parameters are parameters describing different propagation velocities of the seismic wave in different directions of the medium; the vertical propagation velocity is the propagation velocity of the seismic wave in the direction of vertical symmetry axis the medium. The anisotropy parameters and vertical propagation velocity can provide a reliable constraint for lithology analysis of underground rocks, so as to analyze the structural information of the underground objectives, and even the seismic attribute information. Meanwhile, the extracted anisotropy parameters can also provide the necessary anisotropic initial models for offset imaging and inversion.

The attribute parameters of the underground medium, such as the vertical propagation velocity v₀, anisotropy parameters ε and δ, are extracted through dynamic (NMO, normal moveout) correction technique. The dynamic correction is a process of eliminating the difference between the propagation time (or arrival time) of the seismic wave and the arrival time to of the shot point. Herein, the propagation time (or arrival time) is the time that the seismic wave spreads from the hypocenter to the observation site. Conventional dynamic correction methods, such as the dynamic correction method based on the Dix formula, the method of Siliqi (2001) directly using non-hyperbolic approximations and the method of Ursin and Stovas (2006) using the continued fraction expansion, in the extraction of anisotropy parameters, have some drawbacks of low precision and only applied to weak anisotropic medium. Therefore, the dynamic correction methods in the prior art cannot deal with the case with both a long offset and strong anisotropic medium, and the case with either a long offset or strong anisotropic medium with high precision.

### SUMMARY OF THE INVENTION

In order to solve the conventional technical problems, the embodiments of the present invention expect to provide a seismic signal processing method, device and system, which can process the seismic signal in the cases with both a long offset and strong anisotropic medium, and provide a higher precision in the cases with either a long offset or strong anisotropic medium than that of the conventional methods for processing seismic signals.

The technical solutions according to the embodiments of the present invention are as follows:

The embodiments of the present invention provide a seismic signal processing method, comprising:

obtaining an offset of a reflected seismic signal at a sampling point and the corresponding reflected wave arrival time;

constructing an non-hyperbolic dynamic correction formula based on Pade approximation according to the offset of the reflected seismic signal at the sampling point and the corresponding reflected wave arrival time; and

extracting a vertical propagation velocity and anisotropy parameters of the reflected seismic signal according to the non-hyperbolic dynamic correction formula constructed based on Pade approximation.

In the solution above, constructing the non-hyperbolic dynamic correction formula based on Pade approximation according to the offset of the reflected seismic signal at the sampling point and the corresponding reflected wave arrival time comprises:

performing normalization process for the obtained offset of the reflected seismic signal at the sampling point and the reflected wave arrival time; and

constructing a Pade approximation formula of the corresponding relation based on the normalized offset and normalized reflected wave arrival time.

In the solutions above, the Pade approximation formula of the corresponding relation based on the normalized offset and normalized reflected wave arrival time comprises:

$${τ}_{nn}^{2} ( x ) = {R}_{nn} ( x ) = \frac{{\sum }_{k = 0}^{n} {P}_{k} {x}^{2 k}}{{\sum }_{k = 0}^{n} {Q}_{k} {x}^{2 k}} ,$$

wherein x represents the normalized offset, τ(x) represents the normalized reflected wave arrival time, n represents the order of the Pade approximation formula, and Pₖ and Qₖ represent k-th undetermined coefficients.

In the solutions above, extracting a vertical propagation velocity and anisotropy parameters of the reflected seismic signal according to the non-hyperbolic dynamic correction formula constructed based on Pade approximation comprises:

obtaining the normalized reflected wave arrival time τ(x) through the non-hyperbolic dynamic correction formula constructed based on Pade approximation;

calculating the actual offset of the seismic signal and the corresponding reflected wave arrival time by using the normalized offset A's definition x=X/t₀υₙₘₒ and the definition of the normalized reflected wave arrival time τ(x)'s definition, τ(x)=t(X)/t₀; and

obtaining the corresponding vertical propagation velocity and anisotropy parameters of the seismic signal according to the calculated actual offset of the seismic signal and the corresponding reflected wave arrival time.

In the solutions above, when the seismic signal contains seismic signals from multiple geological layers, the method further comprises:

performing layer stripping process for the seismic signal in the analysis of multi-layer anisotropic velocities.

The embodiments of the present invention also provide a seismic signal processing device, comprising: an information obtaining module, a formula constructing module and a parameter extracting module, wherein

the information obtaining module is used for obtaining an offset of a reflected seismic signal at a sampling point and the corresponding reflected wave arrival time;

the formula constructing module is used for constructing a non-hyperbolic dynamic correction formula based on Pade approximation according to the offset of the reflected seismic signal at the sampling point and the corresponding reflected wave arrival time;

the parameter extracting module is used for extracting a vertical propagation velocity and anisotropy parameters of the reflected seismic signal according to the non-hyperbolic dynamic correction formula constructed based on Pade approximation.

In the solution above, the formula constructing module comprise:

a normalization unit, which is used for performing normalization process for the obtained offset of the reflected seismic signal at the sampling point and the reflected wave arrival time; and

a Pade-formula constructing unit, which is used for constructing a Pade approximation formula of the corresponding relation based on the normalized offset and normalized reflected wave arrival time.

In the solutions above, the parameter extracting module comprises:

a formula scanning unit, which is used for obtaining the normalized reflected wave arrival time τ(x) through the non-hyperbolic dynamic correction formula constructed based on Pade approximation;

a parameter calculating unit, which is used for calculating an actual offset of the seismic signal and a corresponding reflected wave arrival time by using the normalized offset A's definition x=X/t₀υₙₘₒ and the normalized reflected wave arrival time τ(x)'s definition τ(x)=t(X)/t₀; and

a result obtaining unit, which is used for obtaining the corresponding vertical propagation velocity and anisotropy parameters of the seismic signal, according to the calculated actual offset of the seismic signal and the corresponding reflected wave arrival time.

In the solutions above, the seismic signal processing device further comprises:

a layer stripping unit, which is used for performing layer stripping process for the seismic signal.

The present invention also provides a seismic signal processing system, comprising any one of the seismic signal processing devices above.

Advantages of the seismic signal processing method, device and system provided by the embodiments of the present invention are those: the present invention processes the seismic signal through the non-hyperbolic dynamic correction formula based on Pade approximation, which can process the case that underground medium has a long offset and strong anisotropy, and provide a higher precision in the case that the underground medium has either strong anisotropy or a long offset than that of the conventional methods for processing seismic signals.

### BRIEF DESCRIPTION OF DRAWINGS

FIG. 1 is a schematic model of the VTI medium according to an embodiment of the present invention.

FIG. 2 is a flow diagram of the seismic signal processing method according to an embodiment of the present invention.

FIG. 3 is a comparison diagram of arrival time curves and the ray tracing results of the reflected waves obtained by the dynamic correction method based on Pade approximation according to an embodiment of the present invention and the conventional dynamic correction method.

FIG. 4 is a distribution diagram of Thomsen anisotropy parameters measured in nature.

FIG. 5 is a stacking diagram of the ray tracing results and seismic records simulated by finite difference according to an embodiment of the present invention.

FIG. 6 is a schematic diagram of a propagation time error between the dynamic correction method based on Pade approximation according to an embodiment of the present invention and the conventional dynamic correction method.

FIG. 7 is a schematic diagram of the results obtained by scanning seismic data through the Alkhalifah method according to an embodiment of the present invention.

FIG. 8 is a schematic diagram of the results obtained by scanning seismic data through the appropriate method based on the Pade[7,7] approximation according to an embodiment of the present invention.

FIG. 9 is a schematic structural view of the seismic signal processing device according to an embodiment of the present invention.

### DETAILED EMBODIMENTS

In order to illustrate the embodiments and the technical solutions of the present invention more clearly, the technical solutions of the present invention will be described in more details with reference to drawings and embodiments. Obviously, the embodiments described herein are merely a part of the embodiments, not all embodiments of the present invention. According to the embodiments of the present invention, all other embodiments obtained by a person skilled in the art without any creative effort are within the scope of the present invention.

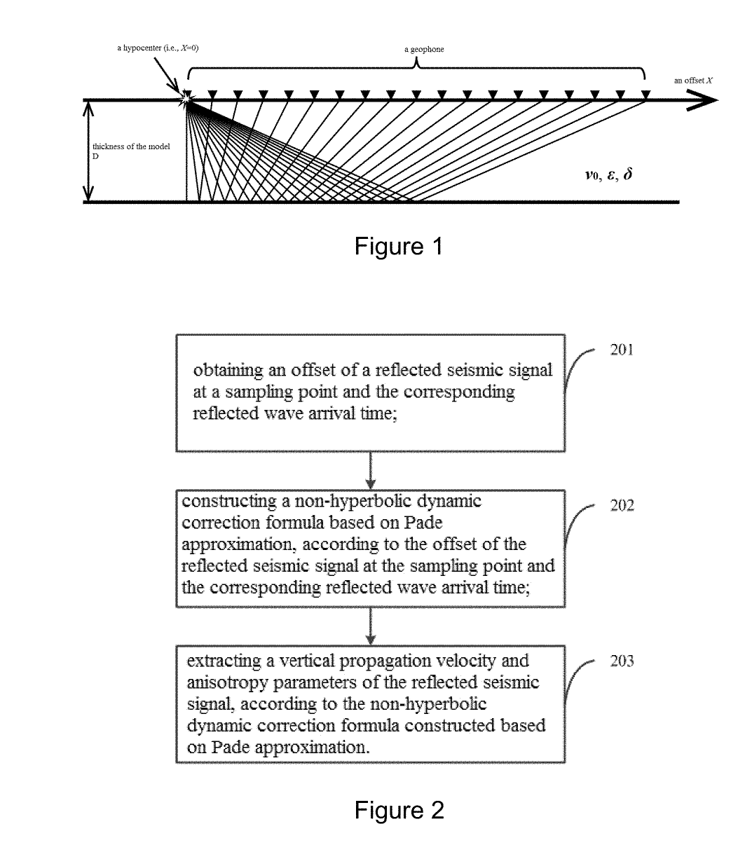

In an embodiment of the present invention, the model of the VTI medium is shown in FIG. 1, wherein the distance X is the offset between the shot and the geophone, D is the thickness of the model, ν₀ is the propagation velocity of the seismic wave in the model, and ε and δ are the Thomsen anisotropy parameters.

In an embodiment of the present invention, the processed seismic signal refers to an electrical signal obtained by a geophone receiving and converting the reflected seismic waves from the underground objects.

In an embodiment of the present invention, the other three conventional methods of extracting the anisotropy parameters are the dynamic correction method based on the Dix formula, the method of Siliqi (2001) directly using non-hyperbolic approximations, and the method of Ursin and Stovas (2006) using the continued fraction expansion. The dynamic correction method based on the Dix formula uses the following non-hyperbolic approximation formula to calculate the square of the reflected wave arrival time at different offsets:

$${τ}^{2} ( x ) = 1 + {x}^{2} - \frac{2 η {x}^{4}}{1 + ( 1 + 2 η ) {x}^{2}} ,$$

wherein τ(x)=t(X)/t₀ represents the normalized reflected wave arrival time, X is the practical offset (i.e., the distance between the shot point and the geophone), x=X/(t₀υₙₘₒ) is the normalized offset (Stovas, 2006), υₙₘₒ is normal moveout (NMO) velocity, t₀ is the reflected wave arrival time at 0 offset, and η is the non-elliptical parameter which is defined as follows (Alkhalifah and Tsvankin, 1995):

$$η = \frac{ɛ - δ}{1 + 2 δ} ,$$

wherein ε and δ are Thomsen anisotropy parameters. When they are not zero, it will lead to the anisotropic phenomenon during the propagation of seismic waves, and the larger their absolute values are, the more obvious the anisotropic effect of geological medium is; Siliqi (2001) directly uses non-hyperbolic approximations to obtain the reflected wave arrival time, the formula is as follows:

$$τ ( x ) = 1 + \frac{1}{1 + 8 η} [ \sqrt{1 + ( 1 + 8 η ) {x}^{2}} - 1 ] ;$$

$$τ ( x ) = 1 + \frac{1}{1 + 8 η} [ \sqrt{1 + ( 1 + 8 η ) {x}^{2}} - 1 ] ;$$

Ursin and Stovas (2006) use the continued fraction expansion to obtain the square of the reflected wave arrival time, the formula is as follows:

$${τ}^{2} ( x ) = 1 + {x}^{2} - \frac{2 η {x}^{4}}{1 + {Bx}^{2}} .$$

The methods above are the most wildly used typical methods of dynamic corrections in the industry. However, these methods have following drawbacks: these methods are not suitable for the case that geological medium has a strong anisotropy (|ε|≧0.2 and/or |δ|≧0.2) and a long offset (offset/objective layer depth>2). Specifically, they are only suitable for the cases with anisotropic parameters |ε|<0.2 and |δ|<0.2 and/or offset/objective layer depth<2, and the dynamic correction formula error will be too large to use the formula when out of the ranges above.

FIG. 2 is a flow diagram of the seismic signal processing method according to the present invention. As shown in FIG. 2, the method comprises:

S201, obtaining an offset of a reflected seismic signal at a sampling point and the corresponding reflected wave arrival time;

particularly, obtaining offsets of reflected seismic signals at different sampling points and the corresponding reflected wave arrival time through receiving reflected seismic signals by the geophone;

S202, constructing a non-hyperbolic dynamic correction formula based on Pade approximation according to the offset of the reflected seismic signal at the sampling point and the corresponding reflected wave arrival time;

Specifically, S202 comprises the following steps:

Step A, performing normalization process for the obtained offset of the reflected seismic signal at the sampling point and the reflected wave arrival time;

particularly, a normalized offset x is defined by x=X/t₀υₙₘₒ; and normalized reflected wave arrival time τ(x) is defined by τ(x)=t(X)/t₀;

Step B, constructing a Pade approximation formula of their corresponding relation based on the normalized offset and normalized reflected wave arrival time;

particularly, the general expression of Pade approximation formula is:

$${R}_{LM} ( x ) = \frac{{P}_{L} ( x )}{{Q}_{M} ( x )} = \frac{{\sum }_{k = 0}^{L} {P}_{k} {x}^{k}}{{\sum }_{k = 0}^{M} {Q}_{k} {x}^{k}} ;$$

then the normalized offset x is taken as an eigenvalue in the above formula, and the normalized reflected wave arrival time τ(x) is taken as a function of x. The non-hyperbolic dynamic correction formula can be constructed based on diagonal Pade approximation:

$${τ}_{nn}^{2} ( x ) = {R}_{nn} ( x ) = \frac{{\sum }_{k = 0}^{n} {P}_{k} {x}^{2 k}}{{\sum }_{k = 0}^{n} {Q}_{k} {x}^{2 k}} ,$$

wherein K=L=n, n is any integer greater than zero, and Pₖ and Qₖ are undetermined coefficients.

Step C, determining the undetermined coefficients Pₖ and Qₖ;

particularly, the undetermined coefficients Pₖ and Qₖ are determined as follows:

Doing the Taylor expansion for a known exact time-space function ƒ(x):

$$f ( x ) = {\sum }_{k = 0}^{∞} {c}_{k} {x}^{k} ,$$

when satisfying ƒ(x)−R_{LM}(x)=O(x^{L+m+1}), that is, the error of the rational expansion R_{LM}(x) and the primitive function ƒ(x) is a high-order infinitesimal of x^{L+M+1}(x<1), R_{LM}(x) is the Pade approximation of ƒ(x). Both sides of the formula ƒ(x)−R_{LM}(x)=O(x^{L+m+1}) are multiplied by the denominator of R_{LM}(x), then the coefficients of the same order x^{k} at both sides of the formula are compared so that the coefficients Pₖ (k=0, 2, . . . , L) and Qₖ (k=0, 2, . . . , M) can be obtained.

Especially, in an embodiment, a corresponding relation between the normalized offset x and the normalized reflected wave arrival time τ(x) is defined based on Pade[4,4] approximation with n=4, that is,

$${τ}_{44}^{2} ( x ) = {R}_{44} ( x ) = \frac{{\sum }_{k = 0}^{4} {P}_{k} {x}^{2 k}}{{\sum }_{k = 0}^{4} {Q}_{k} {x}^{2 k}} = \frac{1 + {\sum }_{k = 1}^{4} {P}_{k} {x}^{2 k}}{1 + {\sum }_{k = 1}^{4} {Q}_{k} {x}^{2 k}} .$$

The coefficients Pₖ and Qₖ (k=1, 2, 3, 4) obtained through the method above are respectively as follows:

$${P}_{1} \text{:} \frac{\begin{matrix}20 + 658 η + 9190 {η}^{2} + 70352 {η}^{3} + 317712 {η}^{4} + \\ 844304 {η}^{5} + 1220224 {η}^{6} + 738752 {η}^{7}\end{matrix}}{5 + 127 η + 1356 {η}^{2} + 7676 {η}^{3} + 24088 {η}^{4} + 39504 {η}^{5} + 26336 {η}^{6}}$$

$${P}_{2} \text{:} \frac{\begin{matrix}30 + 1157 η + 1939 {η}^{2} + 183476 {η}^{3} + 1068752 {η}^{4} + \\ 3919600 {η}^{5} + 8834592 {η}^{6} + 11189952 {η}^{7} + 6100224 {η}^{8}\end{matrix}}{5 + 127 η + 1356 {η}^{2} + 7676 {η}^{3} + 24088 {η}^{4} + 39504 {η}^{5} + 26336 {η}^{6}}$$

$${P}_{3} \text{:} \frac{\begin{matrix}20 + 848 η + 15948 {η}^{2} + 172928 {η}^{3} + 1185968 {η}^{4} + 5325264 {η}^{5} + \\ 15655616 {η}^{6} + 29096192 {η}^{7} + 31094784 {η}^{8} + 14608384 {η}^{9}\end{matrix}}{5 + 127 η + 1356 {η}^{2} + 7676 {η}^{3} + 24088 {η}^{4} + 39504 {η}^{5} + 26336 {η}^{6}}$$

$${p}_{4} \text{:} \frac{\begin{matrix}5 + 222 η + 4440 {η}^{2} + 51968 {η}^{3} + 390680 {η}^{4} + \\ 1957968 {η}^{5} + 6583008 {η}^{6} + 14538752 {η}^{7} + \\ 19895040 {η}^{8} + 14781952 {η}^{9} + 4190720 {η}^{10}\end{matrix}}{5 + 127 η + 1356 {η}^{2} + 7676 {η}^{3} + 24088 {η}^{4} + 39504 {η}^{5} + 26336 {η}^{6}}$$

$${Q}_{1} \text{:} \frac{\begin{matrix}15 + 531 η + 7834 {η}^{2} + 62676 {η}^{3} + \\ 293624 {η}^{4} + 804800 {η}^{5} + 1193888 {η}^{6} + 738752 {η}^{7}\end{matrix}}{5 + 127 η + 1356 {η}^{2} + 7676 {η}^{3} + 24088 {η}^{4} + 39504 {η}^{5} + 26336 {η}^{6}}$$

$${Q}_{2} \text{:} \frac{\begin{matrix}15 + 636 η + 11812 {η}^{2} + 123512 {η}^{3} + 790480 {η}^{4} + \\ 3162976 {η}^{5} + 7719712 {η}^{6} + 10503872 {η}^{7} + 6100224 {η}^{8}\end{matrix}}{5 + 127 η + 1356 {η}^{2} + 7676 {η}^{3} + 24088 {η}^{4} + 39504 {η}^{5} + 26336 {η}^{6}}$$

$${Q}_{3} \text{:} \frac{\begin{matrix}5 + 232 η + 4884 {η}^{2} + 60848 {η}^{3} + 489216 {η}^{4} + 2609248 {η}^{5} + \\ 9177440 {η}^{6} + 20453376 {η}^{7} + 26156032 {η}^{8} + 14608384 {η}^{9}\end{matrix}}{5 + 127 η + 1356 {η}^{2} + 7676 {η}^{3} + 24088 {η}^{4} + 39504 {η}^{5} + 26336 {η}^{6}}$$

$${Q}_{4} \text{:} \frac{\begin{matrix}1080 {η}^{4} + 25152 {η}^{5} + 246560 {η}^{6} + 1301376 {η}^{7} + \\ 3893760 {η}^{8} + 6247936 {η}^{9} + 4190720 {η}^{10}\end{matrix}}{5 + 127 η + 1356 {η}^{2} + 7676 {η}^{3} + 24088 {η}^{4} + 39504 {η}^{5} + 26336 {η}^{6}} .$$

In another embodiment, a corresponding relation between the normalized offset x and the normalized reflected wave arrival time τ(x) is defined based on Pade[7,7] approximation with n=7, that is,

$${τ}_{77}^{2} ( x ) = {R}_{77} ( x ) = \frac{{\sum }_{k = 0}^{7} {P}_{k} {x}^{2 k}}{{\sum }_{k = 0}^{7} {Q}_{k} {x}^{2 k}} = \frac{1 + {\sum }_{k = 1}^{7} {P}_{k} {x}^{2 k}}{1 + {\sum }_{k = 1}^{7} {Q}_{k} {x}^{2 k}} .$$

The coefficients Pₖ and Qₖ (k=1, 2, 3, 4, 5, 6, 7) obtained through the method above are respectively as follows:

P₁=(1928934+177875271×η+7837827462×η²+219632829372×η³+4393725401232×η⁴+66762558665424×η⁵+800282483624416×η⁶+7757101152212224×η⁷+61816601652878720×η⁸+409500878760915968×η⁹+2270674620269779456×η¹⁰+10577274688104635392×η¹¹+41421467806172823552×η¹²+136091600042563719168×η¹³+373312046919000924160×η¹⁴+848038798280195538944×η¹⁵+1576067219935627804672×η¹⁶+2354425649632364789760×η¹⁷+2755347906978845556736×η¹⁸+2429849593769511354368×η¹⁹+1516096215071553748992×η²⁰+595558663830221357056×η²¹+110526504681837953024×η²²)/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

P₂=(5786802+575589969×η+27402488892×η²+830945491596×η³+18017393437944×η⁴+297266111100144×η⁵+3876968360705088×η⁶+40985450564014144×η⁷+357252032884224384×η⁸+2597717830723195392×η⁹+15879010903089374208×η¹⁰+81969396932994297856×η¹¹+358017626105963333632×η¹²+1322357168238845911040×η¹³+4118100751204746092544×η¹⁴+10752767982215247659008×η¹⁵+23337340412356598693888×η¹⁶+41574115402550069166080×η⁷+59708407067590095798272×η¹⁸+67362589572056487559168×η¹⁹+57416164905232919166976×η²⁰+34711631653490820907008×η²¹+13244594083153838080000×η²²+2393573928540571697152×η²³)/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

P₃=(9644670+1016528535×η+51423263424×η²+1661413259772×η³+38484900883368×η⁴+680152787928000×η⁵+9528602090114432×η⁶+108526847831855296×η⁷+1022520875817401856×η⁸+8066274270183933696×η⁹+53717060689940852224×η¹⁰+303577662557579200512×η¹¹+1459995142346725052416×η¹²+5978678247368511492096×η¹³+20814233677401535979520×η¹⁴+61375505707148677595136×η¹⁵+152343562780817632362496×η¹⁶+315415772152951498211328×η¹⁷+537719364162729998548992×η¹⁸+741188745099913124642816×η¹⁸+804734216362744583553024×η²⁰+661814793824070652657664×η²¹+387035816399908829659136×η²²+143219393455221827960832×η³³+25168401484774230720512×η²⁴)/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁶+35970414631180271616×η¹⁶+43640591992815747072×η¹⁷+39793720202662510592×η¹⁸+25609553049671958528×η¹⁹+10350908157396516864×η²⁸+197160155378981273 6×η²¹)

P₄=(9644670+1061012115×η+56187769770×η²+1906082406360×η³+46500030064440×η⁴+868173241337712×η⁵+12889555987110176×η⁶+156091894087908096×η⁷+1569122021197143680×η⁸+13256308026663413760×η⁹+94931570607418164224×η¹+579580149141234107392×η¹¹+3027009907748502867968×η¹²+13543073431265094049792×η¹³+51881658354936538816512×η¹⁴+169777709930246048923648×η¹⁵+472523780210153518759936×η¹⁶+1111087418606925566705664×η¹⁷+2186403098161881572966400×η¹⁸+3553307500792885418131456×η¹⁹+4682291860203479095050240×η²⁰+4873064867923789925580800×η²¹+3851662186402023565426688×η²²+2170557943353311710150656×η²³+776096351861666830352384×η²⁴+132168601394774970204160×η²⁵)/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

P₅=(5786802+655660413×η+35856061830×η²+1259630524044×η³+31916132469504×η⁴+620788649928336×η⁵+9632260563079296×η⁶+122305923730049536×η⁷+1293561923916277632×η⁸+11539439285652457728×η⁹+87595635509731739136×η¹⁰+569272882492753199104×η¹¹+3179636656647032514560×η¹²+15293848493477868236800×η¹³+63367358384507785412608×η¹⁴+225861235067735815340032×η¹⁵+690448514286351392735232×η¹⁶+1801417024902636767477760×η¹⁷+3983110792356283753693184×η¹⁸+7390979589931870290182144×η¹⁹+11355991893219311783247872×η²⁰+14182024077702696639922176×η²¹+14022149691826641035067392×η²²+10554855242750478780465152×η²³+5679097991222977795981312×η²⁴+1944192338541529440190464×η²⁵+318006564232006006210560×η²⁶)/(275562+23048793×η+922612194×η²+23507343720×η³+427711600368×η⁴+5909128384752×η⁶+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

P₆=(1928934+222358851×η+12398103000×η²+445102784100×η³+11554334143416×η⁴+230871063265776×η⁵+3690547741618528×η⁶+48423553021297536×η⁷+530898122265830400×η⁸+4925505742734286592×η⁹+39019858824218919424×η¹⁰+265608094280186059776×η¹¹+1559949387124244523008×η¹²+7923397797552678592512×η¹³+34832234201656515723264×η¹⁴+132440615814478859452416×η¹⁵+434609242879999474434048×η¹⁶+1226339352391968944357376×η¹⁷+2959331825491941912346624×η¹⁸+6061451039088885284732928×η¹⁹+10431257171576328759017472×η²⁰+14876750084992650232987648×η²¹+17255659150501004091326464×η²²+15852942901944734233657344×η²³+11092112127981678147665920×η²⁴+5550124461870301593993216×η²⁵+1768179670704684621889536×η²⁶+269466871890791760920576×η²⁷)/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+11503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

P₇=(275562+31945509×η+1793821140×η²+64961412588×η³+1704160627776×η⁴+34483134232080×η⁵+559500187781824×η⁶+7470118654010240×η⁷+83561375615403648×η⁸+793207525502117632×η⁹+6447977398614715904×η¹⁰+45172677920381583360×η¹¹+273887607136658833408×η¹²+1440713955626014019584×η¹³+6581074491526837641216×η¹⁴+26093407726900327022592×η¹⁵+89638299455484154675200×η¹⁶+265943700421102279262208×η¹⁷+678189291691971688529920×η¹⁸+1476802093336346384400384×η¹⁹+2721935498188550444679168×η²⁰+4196921622869561497878528×η²¹+5329335799228928878444544×η²²+5455238404086497720401920×η²³+4367657736695455202410496×η²⁴+2615332663994183525072896×η²⁵+1089922493261880949211136×η²⁶+277010504006563182673920×η²⁷+31241190228217552699392×η²⁸)/275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

Q₁=(2(826686+77413239×η+3457607634×η²+98062742826×η³+1983006900432×η⁴+30426715140336×η⁵+367971291628032×η⁶+3595794516570912×η⁷+28870198747857280×η⁸+192580767752488064×η⁹+1074789095832259584×η¹⁰+5037045657268359680×η¹¹+19838389139913908224×η¹²+65531999843694247936×η¹³+180680554549787475968×η¹⁴+412438688152760328192×η¹⁵+770048402652223766528×η¹⁸+1155392528819774521344×η¹⁷+1357777093388091523072×η¹⁸+1202120020359919697920×η¹⁹+752872653457078616064×η²⁰+296793531138215772160×η²¹+55263252340918976512×η²²))/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

Q₂=(4133430+421314615×η+20533371210×η²+636665230332×η³+14098394324520×η⁴+237268104020208×η⁵+3152844034218528×η⁶+33922541331609024×η⁷+300642659626650624×η⁸+2220708703532547584×η⁹+13778111397936734720×η¹⁰+72137498475668099072×η¹¹+319347214573271349248×η¹²+1194782547604147429376×η¹³+3766794842815521587200×η¹⁴+9951792481548578947072×η¹⁵+21843566451001500925952×η¹⁶+39335271174172880666624×η¹⁷+57080134064799544246272×η¹⁸+65037936971741973184512×η¹⁹+55961638704418105851904×η²⁰+34138746407529182396416×η²¹+13138010781579579752448×η²²+2393573928540571697152×η²³)/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

Q₃=(4(1377810+149492385×η+7787535210×η²+259114162518×η³+6180167874096×η⁴+112419800046036×η⁸+1620128530120832×η⁶+18969150581351168×η⁷+183589572803618464×η⁸+1486526951974910528×η⁹+10152919806654055040×η¹⁰+58801263872239585280×η¹¹+289584146628032046592×η¹²+1213430419197128672256×η¹³+4319643839733575213056×η¹⁴+13015550590974573481984×η¹⁵+32990004246161177829376×η¹⁶+69702704174107263369216×η¹⁷+121185468513412439408640×η¹⁸+170244660489351100891136×η¹⁹+188263078497808715612160×η²⁰+157589880394364732047360×η²¹+93739206410471443791872×η²²+35255803329349863604224×η²³+6292100371193557680128×η²⁴))/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

Q₄=(4133430+468553815×η+25605680310×η²+897615594648×η³+22656390826320×η⁴+438108906241008×η⁵+6742228840223712×η⁶+84681107416547328×η⁷+883198773982473728×η⁸+7742645820390831616×η⁹+57536031426832966656×η¹⁰+364455198712506151936×η¹¹+1974417941419785115648×η¹²+9159988806870836191232×η¹³+36372615088882275975168×η¹⁴+123319839835275326144512×η¹⁵+355432883417909228699648×η¹⁶+865041016551896630034432×η¹⁷+1760876157015194696155136×η¹⁸+2958545607405671325630464×η¹⁶+4027783529552811685576704×η²⁰+4327745007067682018689024×η²¹+3528725301548983557029888×η²²+2049606239540481072562176×η²³+754593826739385828114432×η²⁴+132168601394774970204160×η²⁵)/275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

Q₅=(2(826686+96308919×η+5427009882×η²+196894550034×η³+5164414595280×η⁴+104238873016848×η⁵+1682460628070880×η⁶+22275247273303488×η⁷+246203045442158592×η⁸+2299954242925295488×η⁹+18316966430868216832×η¹⁰+125095616610351866368×η¹¹+735309014792072728576×η¹²+3726590593337458358272×η¹³+16285963937114949967872×η¹⁴+61280124231354545930240×η¹⁵+197902014621189397643264×η¹⁶+545788559575343499411456×η¹⁷+1276194617518571555127296×η¹⁸+2505058528646059114889216×η¹⁹+4072316943659743137759232×η²⁰+5381115380052287009849344×η²¹+5628762556804139084414976×η²²+4481042550617360469852160×η²³+2548584529843927975460864×η²⁴+921493653485101950959616×η²⁵+159003282116003003105280×η²⁶))/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

Q₆=(275562+32496633×η+1857712158×η²+68549054868×η³+1834083452952×η⁴+37891455487632×η⁵+628466456245984×η⁶+8589030869889280×η⁷+98494511987346304×η⁸+960056884707777280×η⁹+8027700648044889088×η¹⁰+57951806860999945216×η¹¹+362686086208153231360×η¹²+1972364022839890993152×η¹³+9326922280871311966208×η¹⁴+38321172966570882416640×η¹⁵+136490783498625906245632×η¹⁶+419830781828325790646272×η¹⁷+1109016177366253329317888×η¹⁸+2496753260464358062555136×η¹⁹+4741556136527862118744064×η²⁰+7491432251681512087355392×η²¹+9662752109219610376536064×η²²+9907682471796831223283712×η²³+7763656208371979326062592×η²⁴+4364326686884151485792256×η²⁵+1566341751558105880068096×η²⁶+269466871890791760920576×η²⁷)/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹)

Q₇=(128×η⁷(86093442+6841239993×η+259789618440×η²+6270533376300×η³+107931841249680×η⁴+1408828996702656×η⁵+14476512654173952×η⁶+119978955650199744×η⁷+815076528301108224×η⁸+4587220895934600704×η⁹+21525572079369882624×η¹⁰+84473360948626243584×η¹¹+277205625021341642752×η¹²+758245030780603625472×η¹³+1717357845011212746752×η¹⁴+3186134285268034453504×η¹⁵+4763395695841300316160×η¹⁶+5600076296653792083968×η¹⁷+4986276874779718320128×η¹⁸+3161381112437777891328×η¹⁹+1271871501522830360576×η²⁰+244071798657949630464×η²¹))/(275562+23048793×η+922612194×η²+23507343720×η³+427711600368×η⁴+5909128384752×η⁵+64339900368352×η⁶+565512119070400×η⁷+4076204157164160×η⁸+24339343255939840×η⁹+121096428605260288×η¹⁰+503183373567916032×η¹¹+1744689526345007104×η¹²+5027600355175223296×η¹³+11950937819425972224×η¹⁴+23161421974674882560×η¹⁵+35970414631180271616×η¹⁶+43640591992815747072×η¹⁷+39793720202662510592×η¹⁸+25609553049671958528×η¹⁹+10350908157396516864×η²⁰+1971601553789812736×η²¹).

S203, extracting a vertical propagation velocity and anisotropy parameters of the reflected seismic signal according to the non-hyperbolic dynamic correction formula constructed based on Pade approximation;

Particularly, S203 comprises the following steps:

Step a, obtaining the normalized reflected wave arrival time τ(x) (i.e., propagation time parameters) through the non-hyperbolic dynamic correction formula constructed based on Pade approximation;

Specifically, according to reflected wave arrival time obtained at different sampling points, the normalized reflected wave arrival time r corresponding to the zero offset can be calculated by the constructed non-hyperbolic dynamic correction formula constructed based on Pade approximation;

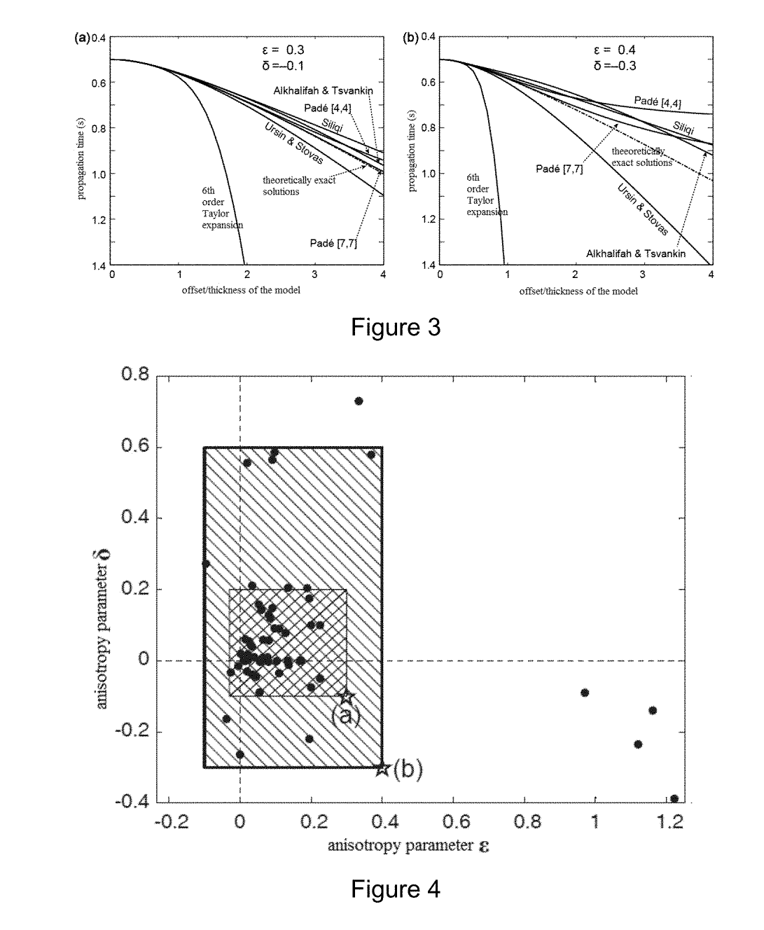

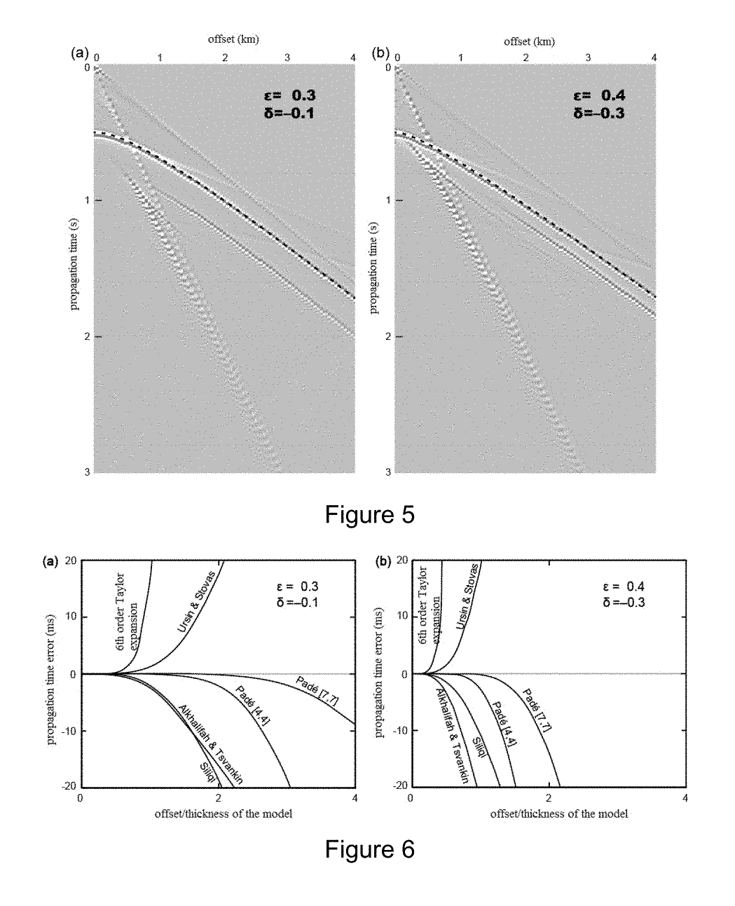

In order to prove that the precision of the method based on Pade approximation is higher than that of conventional methods, FIG. 3 shows, in a particular model, the propagation time obtained by the method based on Pade approximation, the dynamic correction method based on the Dix formula, the method of Siliqi (2001) directly using non-hyperbolic approximations and the method of Ursin and Stovas (2006) using the continued fraction expansion, wherein “Analytical” is the result of ray tracing, which is used as a reference to examine the precision of the approximations described above. FIG. 5 shows a stacking diagram of the ray tracing results (the dotted line) and seismic records simulated by finite difference according to an embodiment of the present invention. As shown in the figure, the ray tracing results match that simulated by finite difference well, so that it can be considered as a precision reference of the approximations described above. As shown in FIG. 3, both methods Pade[4,4] and Pade[7,7] have a high precision, especially the precision of Pade[7,7] method is significantly better than the previous methods in two shown cases.

In FIGS. 3 and 4, the model is the VTI medium model, wherein the thickness of the model is 500 m, the shot point and the geophone are located at the earth surface, the velocity of the model is 2000 m/s, and the corresponding the arrival time to of zero offset is 0.5 s (to =0.5 s). FIG. 4 is a distribution diagram of measured Thomsen anisotropy parameters, wherein the anisotropy parameters corresponding with the two “pentangles” are two groups of anisotropy parameters that are used to make a comparison between an embodiment of the present invention and conventional methods. Specifically, the two groups of parameters are: (a) ç=0.3, δ=−0.1, υₙₘₒ=1.7889 km/s, η=0.5, and (b) ç=0.4, δ=−0.3, υₙₘₒ=1.2649 km/s, η=1.75, and all parameters are strong anisotropy parameters.

Further, on the basis of FIG. 3, FIG. 6 shows reflected wave arrival time curves showing the comparison among ray tracing method and other approximation methods, which can clearly show that, compared to conventional methods, the method based on Pade approximation has a higher precision when dealing with a wider distribution of anisotropy parameters and a lager offset range.

Step b, converting the actual offset of the seismic signal and the corresponding reflected wave arrival time by using the normalized offset A's definition x=X/t₀υₙₘₒ, and the definition of the normalized reflected wave arrival time τ(x)'s definition τ(x)=x=X/t₀.

Step c, obtaining the corresponding vertical propagation velocity and anisotropy parameters of the seismic signal according to the calculated actual offset of the seismic signal and the corresponding reflected wave arrival time.

In particular, the method determining anisotropy parameters according to the reflected wave arrival time belong to conventional methods in the related field, which will not be redundantly explained here.

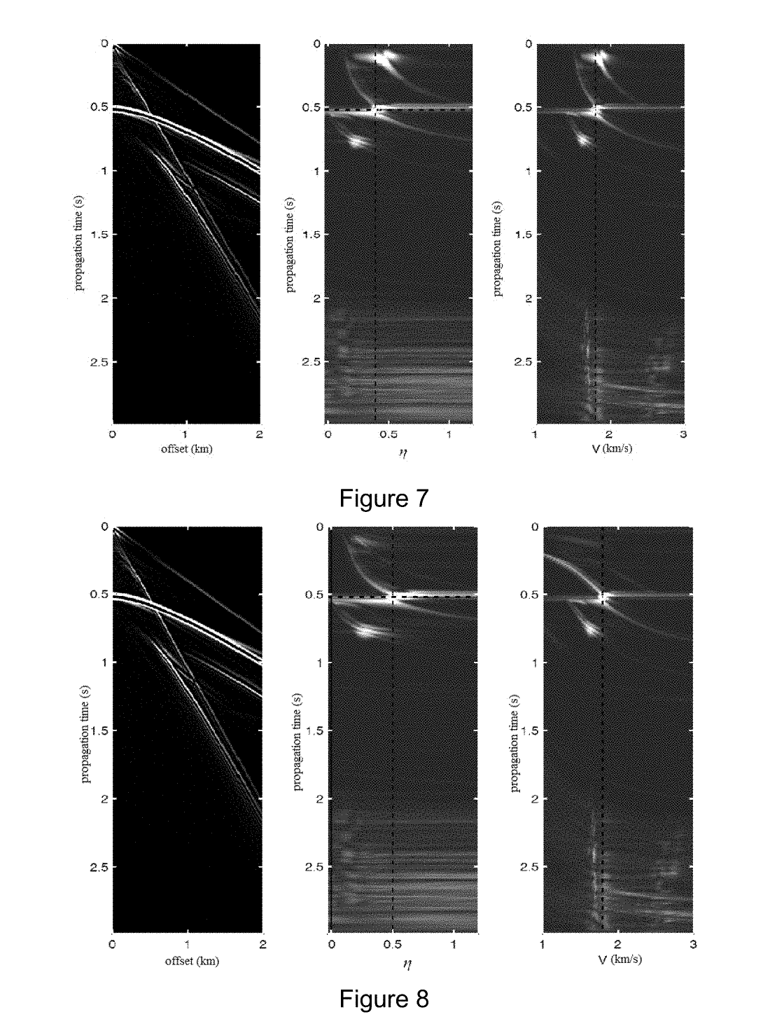

In order to prove that the precision of anisotropy parameters obtained through the method based on Pade approximation is higher, the same seismic data derived from the model is scanned respectively through the conventional Alkhalifah method and the method based on Pade[7,7] approximation to obtain anisotropy parameters and velocities, as shown in FIGS. 7 and 8. FIG. 7 is a schematic diagram of the results obtained by scanning the seismic data derived from the model through the conventional Alkhalifah method, wherein the seismic data are shown on the left, the scanning results of equivalent anisotropy parameters η are shown in the middle, and the scanning results of velocities are shown on the right. FIG. 8 is a schematic diagram of the results obtained by scanning the seismic data derived from the model through the method based on the Pade[7,7] approximation, wherein the seismic data are shown on the left, the scanning results of equivalent anisotropy parameters η are shown in the middle, and the scanning results of velocities are shown on the right.

Herein, the seismic data derived from the model are simulated through the finite difference method according to the elastic wave formula. The model parameters are as follows: ν₀=2000 m/s, ε=0.3, (δ=−0.1, η=(ε−δ)/(1+2δ)=0.5. As shown in FIG. 7, the result η obtained through the conventional Alkhalifah method is 0.39, and the error is 22%; as shown in FIG. 8, the result η obtained through Pade[7,7] approximation is 0.5, and the error is 0%. Thus, it can be seen that the precision of result η obtained through Pade[7,7] approximation is higher than that obtained through the conventional Alkhalifah method.

Further, the structural information of the underground objectives, and even the seismic attribute information can be obtained after calculating anisotropy parameters.

Further, when the seismic signal contains seismic signals from multiple geological layers, the method further comprises:

performing a layer stripping process for the seismic signal in the analysis of multi-layer anisotropic velocities.

Specifically, in order to realize the analysis of multi-layer anisotropic velocities, it is needed to perform the layer stripping process for the seismic signal. The analysis of multi-layer anisotropic velocities can be realized by performing a velocity-independence layer stripping to the records of the current layer, converting reflection records of multiple layers into reflection records of a single layer, and then repeating the velocity analysis process of the single layer model until all of the reflections have been processed. As a result, the analysis of multi-layer anisotropic velocities can be realized.

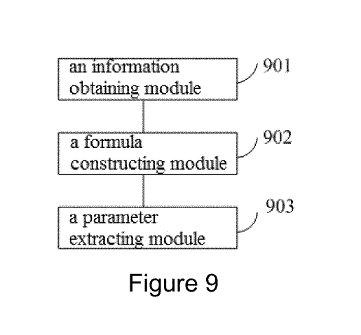

FIG. 9 is a schematic structural view of the seismic signal processing device according to an embodiment of the present invention. As shown in FIG. 9, the seismic signal processing device comprises:

an information obtaining module 901, which is used for obtaining an offset of a reflected seismic signal at a sampling point and the corresponding reflected wave arrival time;

a formula constructing module 902, which is used for constructing an non-hyperbolic dynamic correction formula based on Pade approximation according to the offset of the reflected seismic signal at the sampling point and the corresponding reflected wave arrival time;

a parameter extracting module 903, which is used for extracting a vertical propagation velocity and anisotropy parameters of the reflected seismic signal according to the non-hyperbolic dynamic correction formula constructed based on Pade approximation.

Further, the formula constructing module 902 of the seismic signal processing device above comprises:

a normalization unit, which is used for performing normalization process for the obtained offset of the reflected seismic signal at the sampling point and the reflected wave arrival time;

a Pade-formula constructing unit, which is used for constructing a Pade approximation formula of their corresponding relation based on the normalized offset and normalized reflected wave arrival time.

Further, the parameter extracting module 903 of the seismic signal processing device above comprises:

a formula scanning unit, which is used for obtaining the normalized reflected wave arrival time τ(x) through the non-hyperbolic dynamic correction formula constructed based on Pade approximation;

a parameter calculating unit, which is used for calculating an actual offset of the seismic signal and the corresponding reflected wave arrival time by using the normalized offset x's definition x=X/t₀υₙₘₒ, and the normalized reflected wave arrival time τ(x)'s definition x=X/t₀;

a result obtaining unit, which is used for obtaining the corresponding vertical propagation velocity and anisotropy parameters of the seismic signal according to the calculated actual offset of the seismic signal and the corresponding reflected wave arrival time.

In the solutions above, the seismic signal processing device further comprises:

a layer stripping unit, which is used for performing layer-stripping process for the seismic signal in the analysis of multi-layer anisotropic velocities.

Specifically, the non-hyperbolic dynamic correction formula constructed based on Pade approximation can perform a velocity-independence layer stripping to the records of the current layer, convert reflection records of multiple layers into reflection records of a single layer, and then repeat the velocity analysis process of the single layer model until all of the reflections have been processed, so that the analysis of multi-layer anisotropic velocities can be realized.

The embodiments of the present invention also provide a seismic signal processing system comprising any seismic signal processing device described above.

Advantages of the seismic signal processing method, device and system provided by the embodiments of the present invention are that: the present invention processes the seismic signal through the non-hyperbolic dynamic correction formula based on Pade approximation, which can be applied to the cases that underground medium has a long offset and strong anisotropy at the same time, and in the cases that the underground medium has either strong anisotropy or a long offset, provide a higher precision than that of the conventional seismic signals processing methods.

It will be appreciated by those skilled in the art that embodiments of the present invention may be provided as a method, system, or computer program product. Accordingly, the invention may be implemented as a hardware embodiment, a software embodiment, or an embodiment with the combination of software and hardware. Moreover, the present invention may be a computer program product implemented in one or more computer usable storage medium (including but not limited to a disk storage and optical memory, etc.) containing computer usable program codes.

The present invention has been described with reference to a flowchart and/or block diagram of a method, device (system), and computer program product according to an embodiment of the present invention. It will be appreciated that each process and/or block in the flowchart and/or block diagram, as well as a combination of processes and/or blocks in flowcharts and/or block diagrams, may be implemented by computer program instructions. These computer program instructions may be provided to a processor of a general purpose computer, a dedicated computer, an embedded processor, or other programmable data processing device to generate a machine such that the instructions executed by a processor of a computer or other programmable data processing device can produce a device that implements the functions specified in one or more processes of the flowchart and/or one or more blocks in the block diagram.

These computer program instructions may also be stored in a computer readable memory capable of operating a computer or other programmable data processing device in a particular manner such that instructions stored in the computer readable memory produce a product that includes an instruction device which implements the functions specified in one or more processes of the flowchart and/or one or more blocks in the block diagram.

These computer program instructions may also be loaded onto a computer or other programmable data processing device such that a series of operational steps are performed on the computer or other programmable device to produce computer-implemented processing, so that instructions executed on the computer or other programmable device can provide the steps for implementing the functions specified in one or more processes of the flowchart and/or one or more blocks in the block diagram.

The foregoing is intended only as a preferred embodiment of the present invention and is not intended to limit the scope of the invention.

1. A seismic signal processing method, comprising:
obtaining an offset of a reflected seismic signal at a sampling point and the corresponding reflected wave arrival time;
constructing a non-hyperbolic dynamic correction formula based on Pade approximation according to the offset of the reflected seismic signal at the sampling point and the corresponding reflected wave arrival time;
extracting a vertical propagation velocity and anisotropy parameters of the reflected seismic signal according to the non-hyperbolic dynamic correction formula constructed based on Pade approximation.

2. The seismic signal processing method according to claim 1, wherein constructing the non-hyperbolic dynamic correction formula based on Pade approximation, according to the offset of the reflected seismic signal at the sampling point and the corresponding reflected wave arrival time comprises:
performing normalization process for the obtained offset of the reflected seismic signal at the sampling point and the reflected wave arrival time;
constructing a Pade approximation formula of the corresponding relation based on the normalized offset and normalized reflected wave arrival time.

3. The seismic signal processing method according to claim 2, wherein the Pade approximation formula of the corresponding relation based on the normalized offset and normalized reflected wave arrival time comprises:
$${τ}_{nn}^{2} ( x ) = {R}_{nn} ( x ) = \frac{{\sum }_{k = 0}^{n} {P}_{k} {x}^{2 k}}{{\sum }_{k = 0}^{n} {Q}_{k} {x}^{2 k}} ,$$
wherein x represents the normalized offset, τ(x) represents the normalized reflected wave arrival time, n represents the order of the Pade approximation formula, and Pₖ and Qₖ represent k-th undetermined coefficients.

4. The seismic signal processing method according to claim 1, wherein extracting a vertical propagation velocity and anisotropy parameters of the reflected seismic signal according to the non-hyperbolic dynamic correction formula constructed based on Pade approximation comprises:
obtaining the normalized reflected wave arrival time τ(x) through the non-hyperbolic dynamic correction formula constructed based on Pade approximation;
calculating the actual offset of the seismic signal and the corresponding reflected wave arrival time by using the normalized offset x's definition x=X/t₀υₙₘₒ and the normalized reflected wave arrival time τ(x)'s definition τ(x)=t(X)/t₀;
obtaining the corresponding vertical propagation velocity and anisotropy parameters of the seismic signal according to the calculated actual offset of the seismic signal and the corresponding reflected wave arrival time.

5. The seismic signal processing method according to claim 1, wherein when the seismic signal contains seismic signals from multiple geological layers, the method further comprises:
performing a layer stripping process for the seismic signal in the analysis of multi-layer anisotropic velocities.

6. A seismic signal processing device comprising:
an information obtaining module, a formula constructing module and a parameter extracting module, wherein
the information obtaining module is used for obtaining an offset of a reflected seismic signal at a sampling point and the corresponding reflected wave arrival time;
the formula constructing module is used for constructing an non-hyperbolic dynamic correction formula based on Pade approximation according to the offset of the reflected seismic signal at the sampling point and the corresponding reflected wave arrival time;
the parameter extracting module is used for extracting a vertical propagation velocity and anisotropy parameters of the reflected seismic signal, according to the non-hyperbolic dynamic correction formula constructed based on Pade approximation.

7. The seismic signal processing device according to claim 6, wherein the formula constructing module comprise:
a normalization unit, which is used for performing normalization process for the obtained offset of the reflected seismic signal at the sampling point and the reflected wave arrival time;
a Pade-formula constructing unit, which is used for constructing a Pade approximation formula of the corresponding relation based on the normalized offset and normalized reflected wave arrival time.

8. The seismic signal processing device according to claim 6, wherein the parameter extracting module comprises:
a formula scanning unit, which is used for obtaining the normalized reflected wave arrival time τ(x) through the non-hyperbolic dynamic correction formula constructed based on Pade approximation;
a parameter calculating unit, which is used for calculating the actual offset of the seismic signal and the corresponding reflected wave arrival time by using the normalized offset x's definition x=X/t₀υₙₘₒ and the normalized reflected wave arrival time τ(x)'s definition τ(x)=t(X)/t₀;
a result obtaining unit, which is used for obtaining the corresponding vertical propagation velocity and anisotropy parameters of the seismic signal according to the calculated actual offset of the seismic signal and the corresponding reflected wave arrival time.

9. The seismic signal processing device according to claim 6, wherein the seismic signal processing device further comprises:
a layer stripping unit, which is used for performing a layer stripping process for the seismic signal.

10. A seismic signal processing system comprising the seismic signal processing device according to claim 5.

11. A seismic signal processing system comprising the seismic signal processing device according to claim 6.

12. A seismic signal processing system comprising the seismic signal processing device according to claim 7.

13. A seismic signal processing system comprising the seismic signal processing device according to claim 8.

14. A seismic signal processing system comprising the seismic signal processing device according to claim 9.
